(19) United States
(12) Patent Application Publication
(10) Pub. No.: US 2010/0082939 A1
(43) Pub. Date: Apr. 1, 2010

(54) TECHNIQUES FOR EFFICIENT IMPLEMENTATION OF BROWNIAN BRIDGE ALGORITHM ON SIMD PLATFORMS

(76) Inventors: Jike Chong, Albany, CA (US); Mikhail Smelyanskiy, San Francisco, CA (US); Ram Ramanujam, Portland, OR (US); Victor Lee, San Jose, CA (US)

Correspondence Address: Caven & Aghevli LLC;c/o CPA Global, P.O. BOX 52050, MINNEAPOLIS, MN, 55402, US

(21) Appl. No.: 12/242,411

(22) Filed: Sep. 30, 2008

(51) Int. Cl. G06F 15/00

(52) U.S. Cl. 712/22

(57) ABSTRACT

Methods and apparatus for implementing Brownian Bridge algorithm on Single Instruction Multiple Data (SIMD) computing platforms are described. In one embodiment, a memory stores a plurality of data corresponding to an SIMD (Single Instruction, Multiple Data) instruction. A processor may include a plurality of SIMD lanes. Each of the plurality of the SIMD lanes may process one of the plurality of data stored in the memory in accordance with the SIMD instruction. Other embodiments are also described.

### FIELD

The present disclosure generally relates to the field of computing. More particularly, an embodiment of the invention generally relates to techniques for efficient implementation of Brownian Bridge algorithm on Single Instruction Multiple Data (SIMD) computing platforms.

### BACKGROUND

Monte Carlo simulation is commonly used in computation of financial data, for example, to price an instrument or estimate risks. A significant portion of computation associated with such Monte Carlo simulations is devoted to generating market scenarios according to financial models. Brownian Motion Model is one of the main models for generating scenarios for financial instruments such as stocks. Moreover, Brownian Bridge algorithm is an algorithm for generating values according to the Brownian Motion Model.

Brownian Bridge algorithm may be used to generate market scenario for simulations across hundreds to thousands of time steps. The Brownian Bridge algorithm is currently computed sequentially in a depth-first order. This approach may however be too time-consuming or computationally too expensive for some implementations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a pseudo code associated with the core portion of the Brownian Bridge algorithm, which may be used in some embodiments.

FIG. 2 illustrates a diagram of access patterns corresponding to the Brownian Bridge algorithm, which may be used in some embodiments.

FIGS. 3A, 3B, and 3C illustrate data layouts and memory access procedures, in accordance with some embodiments.

FIG. 4 illustrates a flow diagram of a method according to an embodiment of the invention.

FIGS. 5 and 6 illustrate block diagrams of embodiments of computing systems, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software (including for example micro-code that controls the operations of a processor), or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

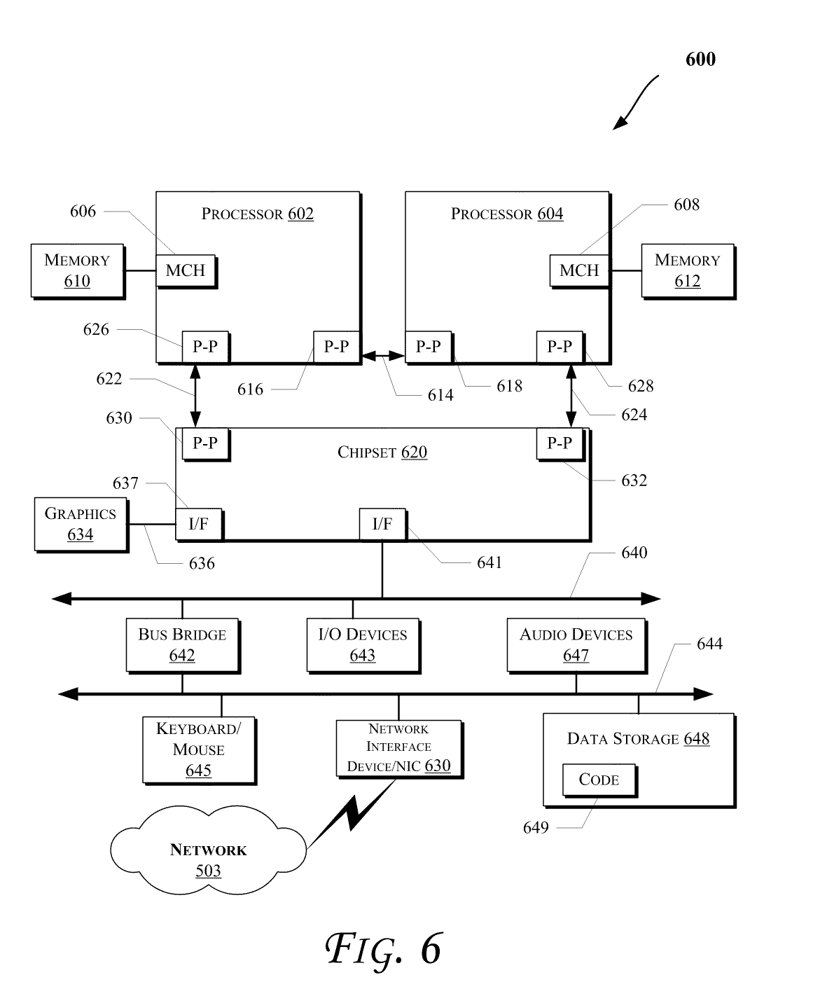

Some of the embodiments discussed herein may present an efficient data layout and/or a procedure (e.g., associated with memory access patterns) to generate an array of stochastic coefficients in accordance with the Brownian Bridge algorithm for efficient execution on an SIMD platform. Generally, SIMD is a technique employed to achieve data level parallelism. In particular, multiple data may be processed in multiple corresponding lanes of an SIMD vector processor (such as processors 502 and 602/604 of FIGS. 5 and 6, respectively) in accordance with a single instruction.

In an embodiment, a data layout and procedure are provided that contain no temporal dependence between lanes in a SIMD word and eliminate expensive gather and scatter memory operations in the inner loop(s) of the Brownian Bridge algorithm. Accordingly, some embodiments may speedup performance by a factor of the SIMD width for large data sets.

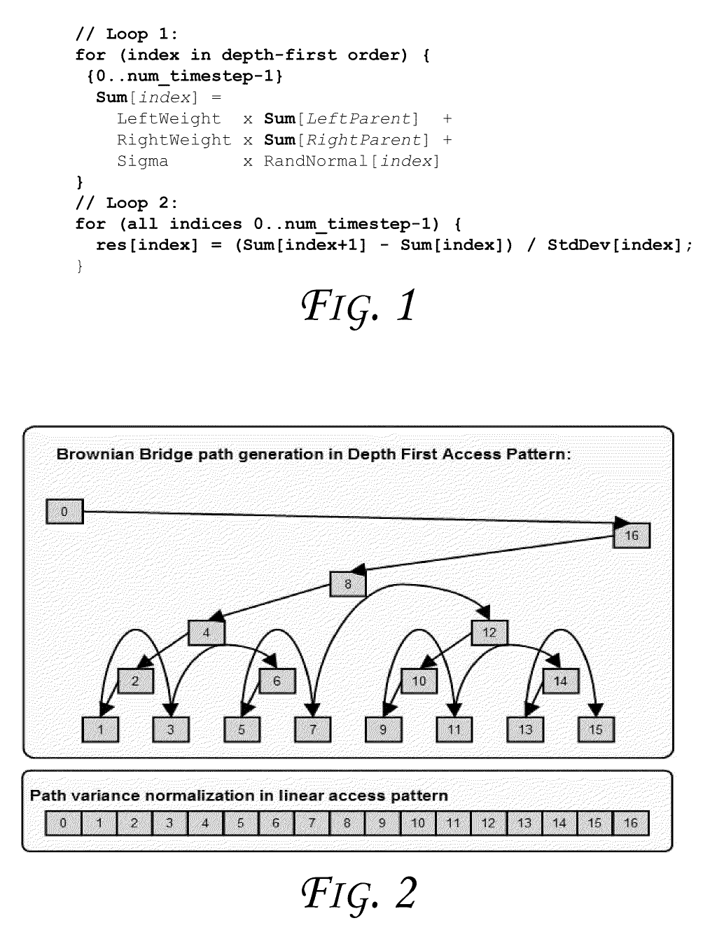

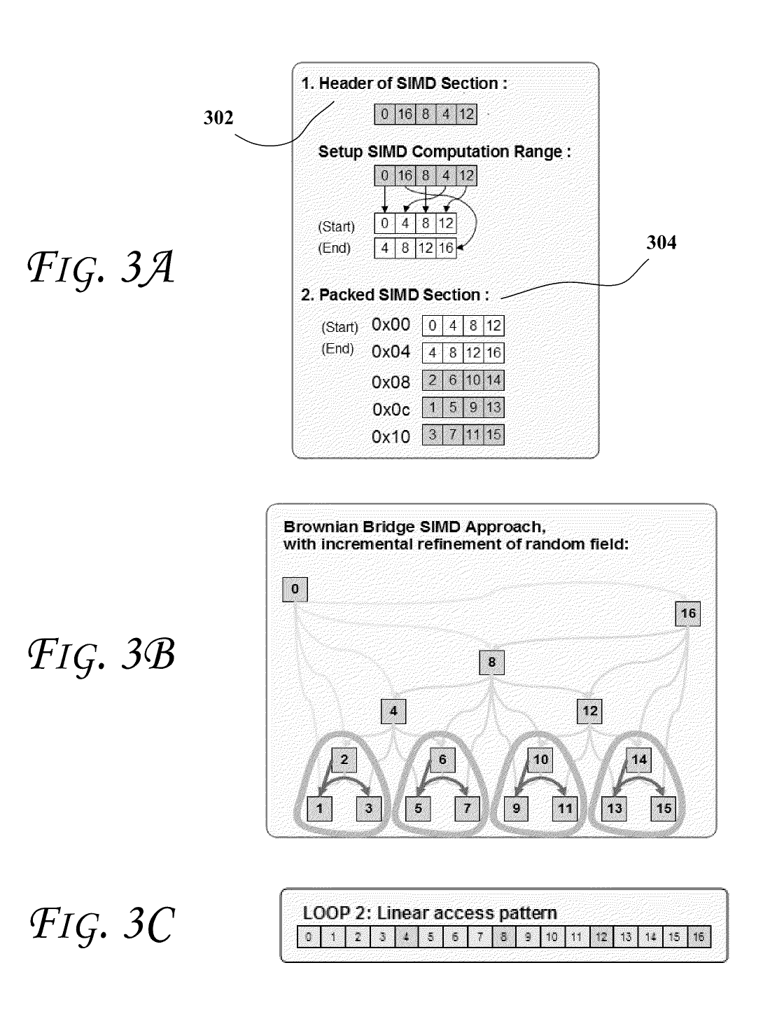

More particularly, FIG. 1 illustrates a pseudo code associated with the core portion of the Brownian Bridge algorithm, which may be used in some embodiments. As shown in FIG. 1, Brownian Bridge algorithm may have two inner loops, referred to as Loop 1 and Loop 2. Generally, the main data structure for Brownian Bridge algorithm includes an array of values corresponding to the Brownian Motion Model. The Brownian Bridge algorithm generates this array by computing each value as the weighted sum of its left and right parents and a stochastic component (referred to as “Sigma” in FIG. 1). The weights may be a function of proximity or closeness of the new data point being generated to its left and right parents, e.g., as determined by the generation sequence of the sub-tree. In one embodiment, the new data point may be at the halfway point between the left and right parents. As shown in FIG. 1, sum of left parents (Sum[LeftParent]) is weighted by LeftWeight and sum of right parents (Sum[RightParent]) is weighted by RightWeight. The sigma may be a metric of the expected variance in the scenario being generated. In one embodiment in the field of quantitative finance, the sigma may be a function of the implied volatility of and underlying asset or derivative. Furthermore, the algorithm does this in a depth-first tree traversal order (Loop 1), such as shown in FIG. 2. Then, the algorithm traverses the same array in linear order to normalize the differences between immediate neighbors. As shown in FIG. 1, Loop 2 determines the result as the difference in two neighboring sums (Sum[index+1]−Sum[index]) divided by the standard deviation (StdDev[index]) in linear order.

Moreover, FIG. 2 illustrates a diagram of access patterns corresponding to the Brownian Bridge algorithm, which may be used in some embodiments. As discussed with reference to FIG. 1, the Brownian Bridge algorithm has two memory access patterns over its array. Loop 1 accesses memory in depth-first order and Loop 2 accesses memory in linear order, such as shown in FIG. 2. Furthermore, to efficiently generate a random path or field using Brownian Bridge algorithm on a SIMD platform, a data structure in linear order is generally not suitable for SIMD operation. For example, there can be data dependencies that are not in the linear order, but in depth-first order. Reordering the data in the depth-first order is also not amenable for SIMD for the same reason. Other approaches such as traversal tree level-wise SIMD, which computes a node value at the same traversal-tree-depth in SIMD requires significant gather and scatter operations.

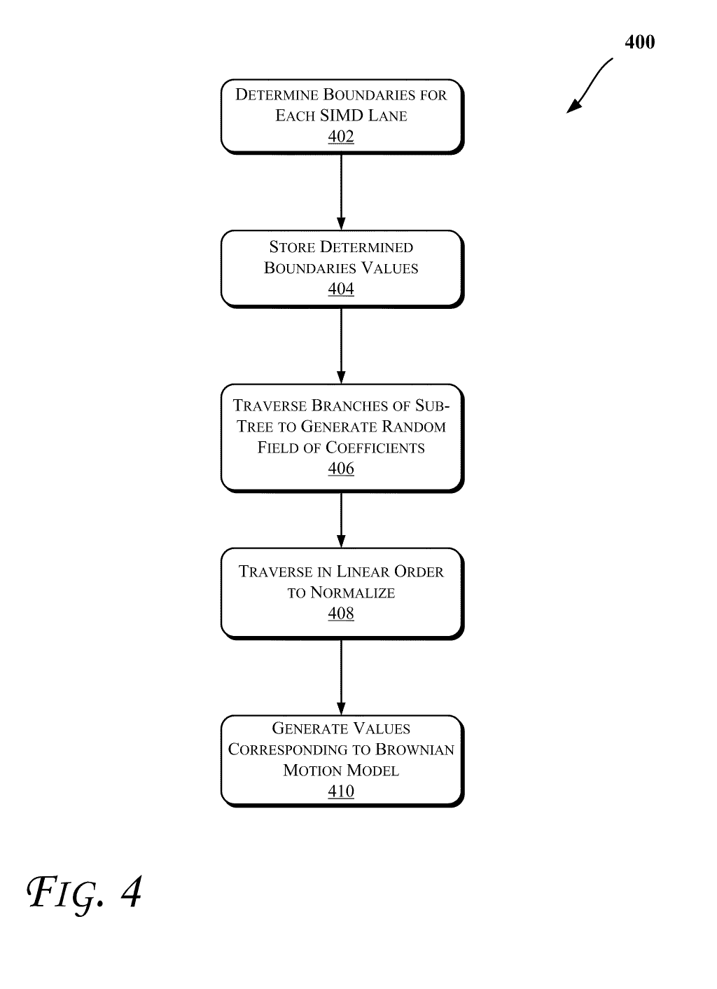

Referring to FIGS. 3A, 3B, and 3C, a data layout and memory access procedure are used to achieve high SIMD efficiency by partitioning and aligning computations to SIMD lanes and eliminating gather scatter operations for both access patterns in the Brownian Bridge algorithm, in accordance with some embodiments.

More specifically, FIG. 3A illustrates a sample data layout, in accordance with an embodiment. As shown in FIG. 3A, the data layout may include two sections: (a) Header Section 302: two SIMD-width vectors are shown specifying the begin and end index for the sub-trees in a SIMD lane; and (b) Packed SIMD Section 304: each SIMD lane traverses a sub-tree in depth-first order. In some embodiments, the starting and ending values may be replicated or duplicated to ensure that the reorganized data structure is usable for both operations. In some embodiments, the sub-tree may be traversed in any other order, as long as the LeftWeight and RightWeight shown in FIG. 1 are adjusted accordingly.

FIG. 3B illustrates data access patterns for Brownian Bridge loops, according to an embodiment. For example, FIG. 3B illustrates the data access patterns for the data layouts of FIG. 3A. FIG. 3C illustrates a data access pattern for a normalization loop, according to an embodiment.

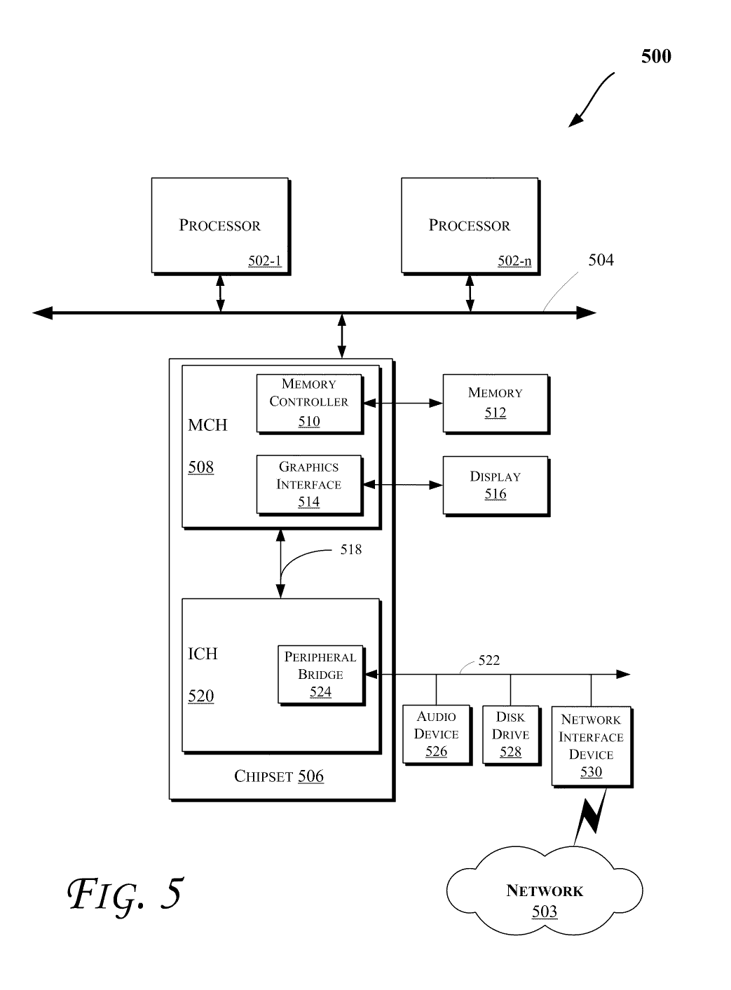

FIG. 4 illustrates a method 400 to perform operations corresponding to the Brownian Bridge algorithm for efficient execution on an SIMD platform, in accordance with an embodiment. Various components discussed herein (such as those discussed with reference 5 and 6) may be used to perform one or more operations of method 400. For example, the processors discussed with reference to FIGS. 5 and 6 may be capable of performing operations in an SIMD fashion and various storage devices discussed with reference to FIGS. 5 and 6 may store data discussed herein with reference to FIGS. 1-4.

Referring to FIGS. 1-4, at an operation 402, begin boundary and end boundary (also referred to herein as “point”) for each lane of SIMD are determined (e.g., one SIMD width number of points). At an operation 404, the determined begin and end points are stored in two SIMD words in the Header section of the data layout (e.g., see FIG. 3A). In an embodiment, computations of operation 402 are performed in as parallel fashion as possible, e.g., take log(SIMD width) number of operations.

At an operation 406, the branches of a sub-tree are traversed (e.g., in depth-first such as discussed with reference to FIG. 3B) to generate a random field of coefficients. In an embodiment, the branches are traversed depth-first concurrently in each SIMD lanes. The left parents and right parents are generated/computed internal to each lane, and all left/right parents in an SIMD word are generated at the same time in the same SIMD word. Hence, no gather and scatter operations may be necessary in Loop 1 of the Brownian Bridge algorithm.

At operation 408, normalization may be performed through a linear order traversal. For example, the difference between two time steps is normalized to make the generated random field confirm to the Brownian Motion Model (e.g., for a financial model). In an embodiment, Loop 2 may take pairs of neighboring and normalize them. The packed SIMD data layout (discussed with reference to FIG. 3A) supports this access pattern. In the example shown in FIGS. 3A-3C, SIMD word at 0x08 and 0x10 may be loaded and array positions 2, 6, 10, and 14 may be computed at the same time in SIMD, and immediately afterwards, SIMD word at 0x10 and 0x04 may be loaded and array position 3, 7, 11, 15 may be computed at the same time in SIMD. This access pattern efficiently utilizes memory bandwidth, cache temporal and spatial locality, and SIMD computation efficiency.

Generally, Brownian Motion Model models a variety of real world phenomenon ranging from physics and chemistry to finance and economics, but is generated in a highly sequential and iterative method. The Brownian Bridge algorithm can generate a set of value that conform to the Brownian Motion Model (e.g., at operation 410) and is effective in exposing parallelism in the process. Some of the embodiments discussed herein may be very effective in harnessing the parallelism on SIMD architectures, which may, in turn, enable higher performance usage of the Brownian Motion Model in various fields, such as the fields mentioned above. To this end, in some embodiments, a data layout and access procedure are used to achieve high SIMD efficiency for the Brownian Bridge algorithm by aligning and partitioning computation into SIMD lanes and eliminating gather scatter operations for data access patterns in both loops in the algorithm.

FIG. 5 illustrates a block diagram of an embodiment of a computing system 500. In various embodiments, one or more of the components of the system 500 may be provided in various electronic devices capable of performing one or more of the operations discussed herein with reference to some embodiments of the invention. For example, one or more of the components of the system 500 may be used to perform the operations discussed with reference to FIGS. 1-4, e.g., by generating values corresponding to Brownian Motion Model by enhanced performance through use of SIMD, etc. in accordance with the operations discussed herein. Also, various storage devices discussed herein (e.g., with reference to FIG. 5 and/or 6) may be used to store data, operation results, etc. In one embodiment, data associated with operations of method 400 of FIG. 4 may be stored in memory device(s) (such as memory 512 or one or more caches (e.g., L1 caches in an embodiment) present in processors 502 of FIG. 5 or 602/604 of FIG. 6). These processors may then apply the operations discussed herein in accordance with Brownian Bridge algorithm (such as one or more of the operations of FIGS. 1-4). Accordingly, in some embodiments, processors 502 of FIG. 5 or 602/604 of FIG. 6 may be vector processors that are capable of supporting SIMD operations.

Moreover, the computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. Additionally, the processors 502 may utilize an SIMD architecture. Moreover, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512. The memory 512 may store data, including sequences of instructions that are executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a display 516. The display 516 may be used to show a user results of operations associated with the Brownian Bridge algorithm discussed herein. In one embodiment of the invention, the graphics interface 514 may communicate with the display 516 via an accelerated graphics port (AGP). In an embodiment of the invention, the display 516 may be a flat panel display that communicates with the graphics interface 514 through, for example, a signal converter that translates a digital representation of an image stored in a storage device such as video memory or system memory into display signals that are interpreted and displayed by the display 516. The display signals produced by the interface 514 may pass through various control devices before being interpreted by and subsequently displayed on the display 516.

A hub interface 518 may allow the MCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530, which may be in communication with the computer network 503. In an embodiment, the device 530 may be a NIC capable of wireless communication. Other devices may communicate via the bus 522. Also, various components (such as the network interface device 530) may communicate with the MCH 508 in some embodiments of the invention. In addition, the processor 502 and the MCH 508 may be combined to form a single chip. Furthermore, the graphics interface 514 may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration such as discussed with reference to FIG. 6. For example, processors, memory, and/or input/output devices may be interconnected by a number of point-to-point interfaces.

More specifically, FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-4 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to couple with memories 610 and 612. The memories 610 and/or 612 may store various data such as those discussed with reference to the memory 512 of FIG. 5.

The processors 602 and 604 may be any suitable processor such as those discussed with reference to the processors 502 of FIG. 5. The processors 602 and 604 may exchange data via a point-to-point (PtP) interface 614 using PtP interface circuits 616 and 618, respectively. The processors 602 and 604 may each exchange data with a chipset 620 via individual PtP interfaces 622 and 624 using point to point interface circuits 626, 628, 630, and 632. The chipset 620 may also exchange data with a high-performance graphics circuit 634 via a high-performance graphics interface 636, using a PtP interface circuit 637.

At least one embodiment of the invention may be provided by utilizing the processors 602 and 604. For example, the processors 602 and/or 604 may perform one or more of the operations of FIGS. 1-4. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may be coupled to a bus 640 using a PtP interface circuit 641. The bus 640 may have one or more devices coupled to it, such as a bus bridge 642 and I/O devices 643. Via a bus 644, the bus bridge 643 may be coupled to other devices such as a keyboard/mouse 645, the network interface device 630 discussed with reference to FIG. 6 (such as modems, network interface cards (NICs), or the like that may be coupled to the computer network 503), audio I/O device, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software (including, for example, micro-code that controls the operations of a processor such as the processors discussed with reference to FIGS. 5-6), firmware, or combinations thereof, which may be provided as a computer program product, e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed with respect to FIGS. 5-6.

Additionally, such tangible computer-readable media may be downloaded as a computer program product, wherein the program may be transferred from a remote computer (e.g., a server) to a requesting computer (e.g., a client) by way of data signals embodied in propagation medium via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a memory to store a plurality of data corresponding to an SIMD (Single Instruction, Multiple Data) instruction; and
a processor having a plurality of SIMD lanes, wherein each of the plurality of the SIMD lanes is to process one of the plurality of data stored in the memory in accordance with the SIMD instruction, wherein the processor is to:
determine a starting boundary and an ending boundary for each of the plurality of SIMD lanes;
traverse branches of a sub-tree corresponding to a Brownian Bridge algorithm to generate a random field of coefficients; and
normalize the generated random field of coefficients to generate values corresponding to Brownian Motion Model.

2. The apparatus of claim 1, wherein the processor is to traverse the branches in depth-first order concurrently for the plurality of the SIMD lanes.

3. The apparatus of claim 1, wherein the processor is to linearly traverse branches corresponding to the Brownian Bridge algorithm to normalize the generated random field of coefficients across SIMD lanes in parallel.

4. The apparatus of claim 1, wherein the processor is to cause storage of the starting boundary and the ending boundary in a header section of corresponding SIMD words.

5. The apparatus of claim 1, wherein the processor is to concurrently generate all left and right parent values, for each node of a tree corresponding to the Brownian Bridge algorithm, in an SIMD word.

6. The apparatus of claim 1, wherein the memory comprises a cache.

7. The apparatus of claim 1, wherein the processor comprises one or more processor cores.

8. The apparatus of claim 1, wherein the processor is to cause storage of the generated values in the memory.

9. A method comprising:
storing a plurality of data corresponding to an SIMD (Single Instruction, Multiple Data) instruction;
determining a starting boundary and an ending boundary for each of a plurality of SIMD lanes;
traversing branches corresponding to a Brownian Bridge algorithm to generate a random field of coefficients; and
normalizing the generated random field of coefficients to generate values corresponding to Brownian Motion Model.

10. The method of claim 9, further comprising concurrently generating all left and right parent values in an SIMD word.

11. The method of claim 9, further comprising traversing the branches in depth-first order concurrently for the plurality of the SIMD lanes.

12. The method of claim 9, further comprising linearly traversing branches corresponding to the Brownian Bridge algorithm to normalize the generated random field of coefficients across SIMD lanes in parallel.

13. The method of claim 9, further comprising storing the starting boundary and the ending boundary in a header section of corresponding SIMD words.

14. The method of claim 9, further comprising storing the generated values in the memory.

15. A computer-readable medium comprising one or more instructions that when executed on a processor configure the processor to perform one or more operations to:
store a plurality of data corresponding to an SIMD (Single Instruction, Multiple Data) instruction;
determine a starting boundary and an ending boundary for each of a plurality of SIMD lanes;
traverse branches corresponding to a Brownian Bridge algorithm to generate a random field of coefficients; and
normalize the generated random field of coefficients to generate values corresponding to Brownian Motion Model.

16. The computer-readable medium of claim 15, further comprising one or more instructions that when executed on a processor configure the processor to perform one or more operations to concurrently generate all left and right parent values in an SIMD word.

17. The computer-readable medium of claim 15, further comprising one or more instructions that when executed on a processor configure the processor to perform one or more operations to traverse the branches in depth-first order concurrently for the plurality of the SIMD lanes.

18. The computer-readable medium of claim 15, further comprising one or more instructions that when executed on a processor configure the processor to perform one or more operations to linearly traverse branches corresponding to the Brownian Bridge algorithm to normalize the generated random field of coefficients across SIMD lanes in parallel.

19. The computer-readable medium of claim 15, further comprising one or more instructions that when executed on a processor configure the processor to perform one or more operations to store the starting boundary and the ending boundary in a header section of corresponding SIMD words.

20. The computer-readable medium of claim 15, further comprising one or more instructions that when executed on a processor configure the processor to perform one or more operations to store the generated values in the memory.
